(19) United States
(12) Patent Application Publication
(10) Pub. No.: US 2017/0127184 A1
(43) Pub. Date: May 4, 2017

(54) WIRELESS SPEAKER SYSTEM

(71) Applicant: AC (MACAO COMMERCIAL OFFSHORE) LIMITED, Macau (MO)

(72) Inventors: Brian Mertel, Simpsonville, SC (US); Daniel Nelson, Anderson, SC (US)

(21) Appl. No.: 15/336,929

(22) Filed: Oct. 28, 2016

Related U.S. Application Data
(60) Provisional application No. 62/248,481, filed on Oct. 30, 2015.

(51) Int. Cl. H04R 3/12; H04R 1/02

(52) U.S. Cl. CPC H04R 3/12; H04R 1/02; H04R 2420/07

(57) ABSTRACT

A speaker system including a main speaker unit and a satellite speaker unit. The main speaker unit includes a battery receptacle configured to receive a battery pack. The main speaker unit is configured to receive an audio signal from a device using a first communications protocol and output the audio signal using a second communications protocol. The satellite speaker unit includes a satellite battery receptacle configured to receive a second battery pack. The satellite speaker unit is configured to receive the audio signal from the main speaker unit using the second communications protocol.

### RELATED APPLICATIONS

The present application claims priority to U.S. Provisional Application No. 62/248,481, filed Oct. 30, 2015, the entire contents of which are hereby incorporated.

### FIELD

The present application relates to speakers and speaker systems.

### SUMMARY

Speaker systems may receive an audio signal from an external device and output audio, via a speaker device, corresponding to the received audio signal. Wired speaker systems may be limited to a single room or area, while wireless speaker systems may be limited to a single speaker unit located at a single location.

Thus, in one embodiment, the application provides a speaker system including a main speaker unit and a satellite speaker unit. The main speaker unit includes a battery receptacle configured to receive a battery pack. The main speaker unit is configured to receive an audio signal from a device using a first communications protocol and output the audio signal using a second communications protocol. The satellite speaker unit includes a satellite battery receptacle configured to receive a second battery pack. The satellite speaker unit is configured to receive the audio signal from the main speaker unit using the second communications protocol.

In another embodiment the application provides a speaker unit including a battery receptacle, a communications module, and a speaker. The battery receptacle is configured to receive a battery pack. The communications module is configured to receive an audio signal using a first communications protocol and output the audio signal using a second communications protocol. The speaker is configured to output sound corresponding to the audio signal.

Other aspects of the application will become apparent by consideration of the detailed description and accompanying drawings.

### BRIEF DESCRIPTION OF THE DRAWINGS

FIG. 1 illustrates a speaker system according to some embodiments of the application.

FIG. 2 is a front perspective view of a main speaker unit of the speaker system of FIG. 1 according to some embodiments of the application.

FIG. 3 is a rear perspective view of the main speaker unit of FIG. 2 according to some embodiments of the application.

FIG. 4 is a block diagram of a main control system of the main speaker unit of FIGS. 2 & 3 according to some embodiments of the application.

FIG. 5 is a front perspective view of a satellite speaker unit of the speaker system of FIG. 1 according to some embodiments of the application.

FIG. 6 is a block diagram of a satellite control system of the satellite speaker unit of FIG. 5 according to some embodiments of the application.

FIG. 7 illustrates a speaker system according to another embodiment of the application.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

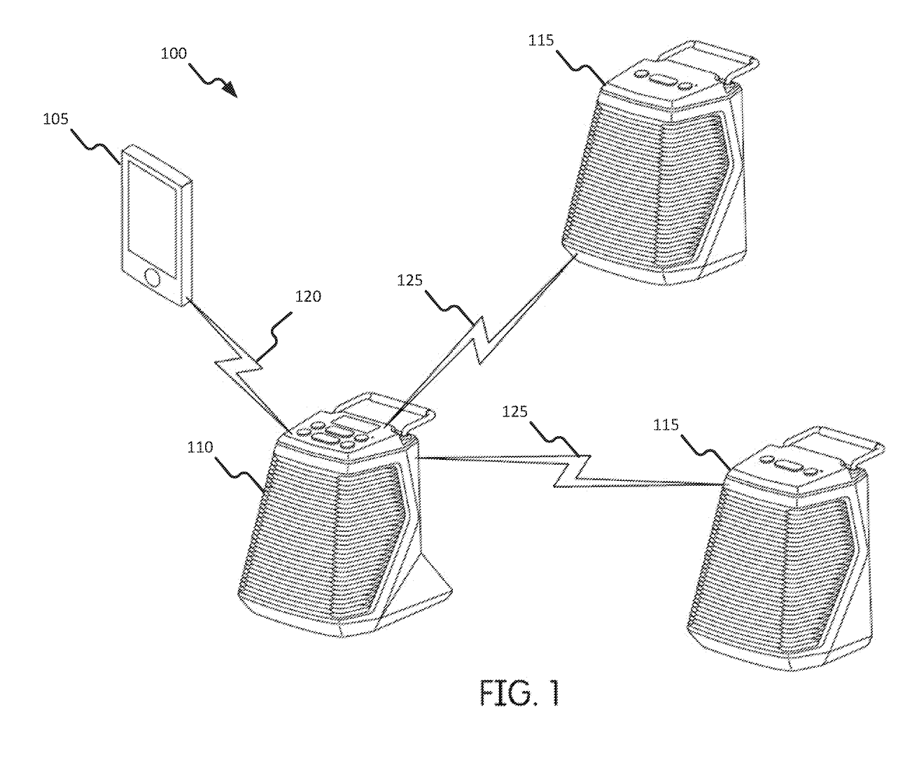

FIG. 1 illustrates a speaker system 100 according to some embodiments of the application. The speaker system 100 includes a device 105, a main speaker unit 110, and at least one satellite speaker unit 115.

The device 105 may be a computing device including, but not limited to, a smart phone, a tablet, a laptop, and a computer. The device 105 may be configured to output an audio signal to the main speaker unit 110 via a first communications link 120. The main speaker unit 110 may receive the audio signal and convert the audio signal to sound. The main speaker unit 110 may further output the audio signal to the one or more satellite speaker units 115 via a second communications link 125. The one or more satellite speaker units 115 may then convert the audio signal to sound.

The first and second communications links 120, 125 may employ one or more communications protocols. For example, the first and second communications links 120, 125 may employ a Bluetooth protocol, a SKAA protocol, an Ad Hoc network (for example, ad hoc WiFi), a WiFi protocol, etc. In some embodiments, the first communications link 120 and the second communications link 125 are substantially similar. In another embodiments, the first communications link 120 and the second communications link 125 are different.

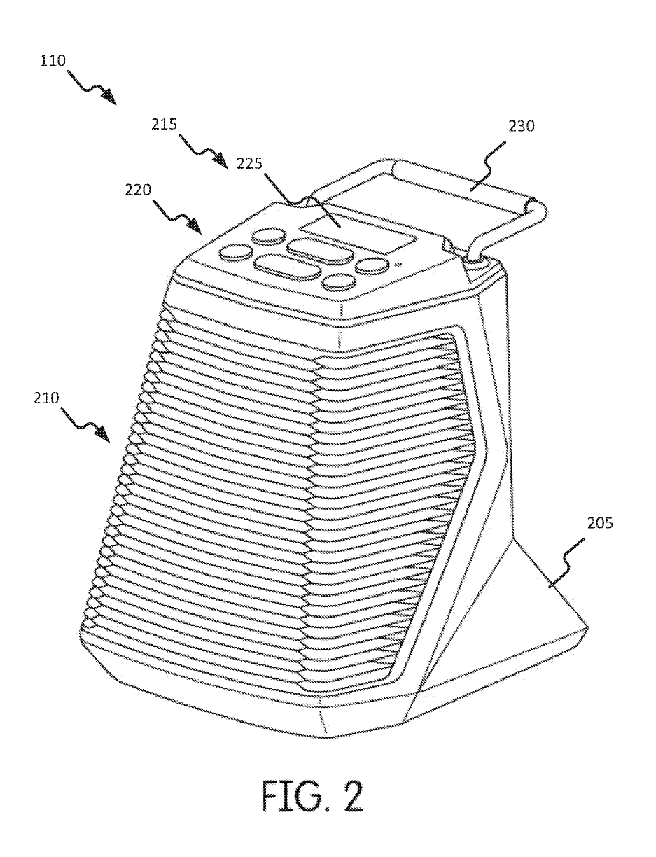

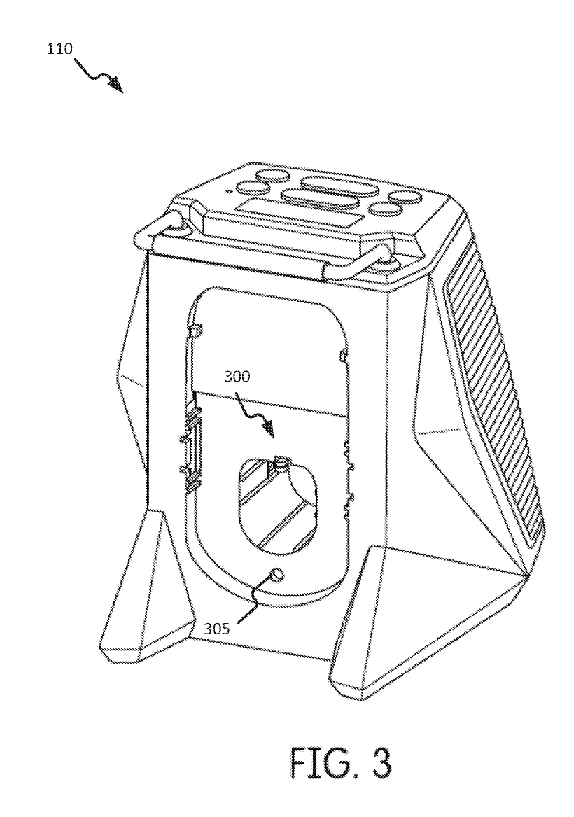

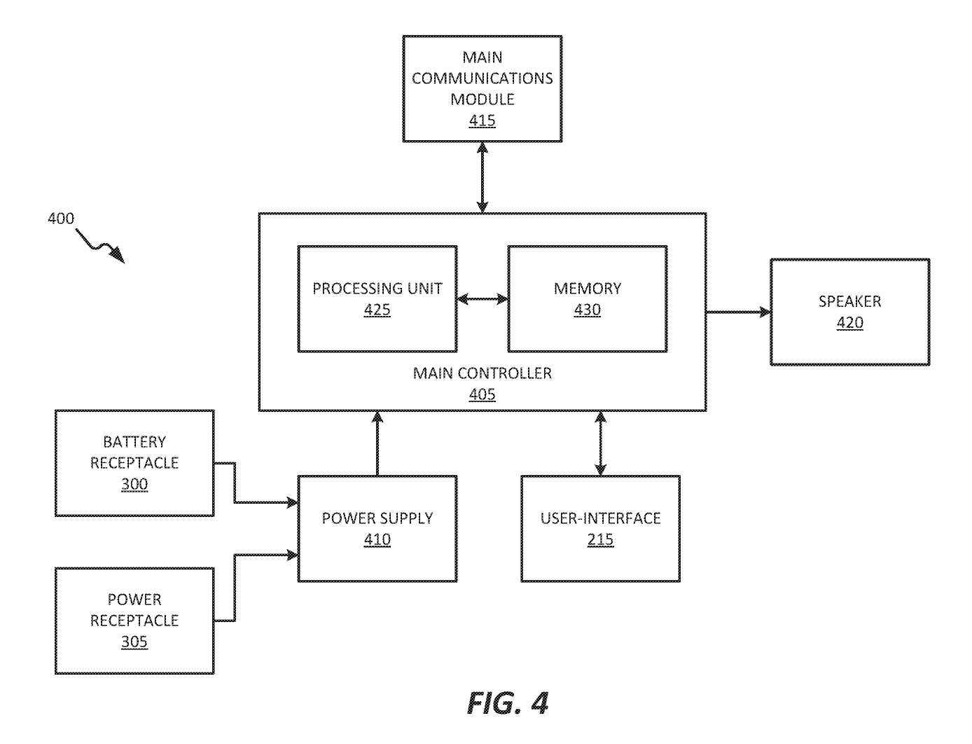

FIGS. 2 and 3 illustrate the main speaker unit 110 according to some embodiments of the application. The main speaker unit 110 includes a housing 205. The housing 205 may be formed of plastic or a similar material. The housing 205 includes a speaker grill 210 configured to cover a main speaker 420 (FIG. 4). The main speaker unit 110 further includes a main user-interface 215 including input devices 220 and a display 225. In some embodiments, such as illustrated, the main speaker unit 110 further includes a handle 230 coupled to the housing 205.

As illustrated in FIG. 3, the housing 205 defines a battery receptacle 300. The battery receptacle 300 is configured to receive a battery pack, such as but not limited to a power tool battery pack. The battery pack may include a battery pack housing containing one or more battery cells connected in a series-type and/or parallel-type configuration. In some embodiments, the battery cells may have a lithium-ion chemistry. The battery pack housing may further include a battery pack interface configured to physically couple to the battery receptacle 300.

The battery receptacle 300 may further include power receptacle 305. The power receptacle 305 may receive a line voltage, for example an alternating-current (AC) line voltage or direct-current (DC) line voltage.

FIG. 4 is a block diagram of a main control system 400 of the main speaker unit 110 according to some embodiments of the application. The main control system 400 includes a main controller 405 electrically and/or communicatively coupled to a power supply 410, a main communications module 415, the main speaker 420, and the user-interface 215. The main controller 405 includes a plurality of electrical and electronic components that provide power, operational control, and protection to the components and modules within the main controller 405 and/or the main speaker unit 110. For example, the controller 405 includes, among other things, a main processing unit 425 (e.g., a microprocessor, a microcontroller, or another suitable programmable device) and a main memory 430. In some embodiments, the controller 405 is implemented partially or entirely on a printed circuit board or a semiconductor (e.g., a field-programmable gate array [“FPGA”] semiconductor) chip, such as a chip developed through a register transfer level (“RTL”) design process.

The power supply 410 supplies a nominal voltage to the controller 405. The power supply 410 is configured to receive power from a battery pack coupled to the battery receptacle 300 or the power receptacle 305. The power supply 410 converts power received from the battery pack or power receptacle 305 into the nominal voltage.

The main communications module 415 provides communications links (for example, first communications link 120, second communications link 125, etc.) between the main speaker unit 110 and external devices (for example, device 105, satellite speaker unit 115, another main speaker unit, etc.). The communications links provided by the communications module 415 may be wired communications links, wireless communications links or a combination of wired and wireless communications links. The main communications module 415 may include a port (for example, an auxiliary port, a universal serial bus (USB) port, etc.) for providing the wired communications link. The main communications module 415 may further include a main transmitter and a main receiver, or a main transceiver for providing the wireless communications links.

The communications module 415 employs one or more communications protocols, such as but not limited to, a Bluetooth protocol, a SKAA protocol, an Ad Hoc network (for example, ad hoc WiFi), and a WiFi protocol. In some embodiments, the communications links provided by the communications module 415 may use a network, for example, a wide area network (WAN), a local area network (LAN), or a personal area network (PAN).

The main speaker 420 is configured to convert the audio signal into a corresponding sound. The main speaker 420 may be any electroacoustic transducer or transducers that produces sound in response to the received audio signal. Although illustrated as a single speaker, the main speaker 420 may include one or more speaker components, such as but not limited to, one or more drivers, one or more woofers, and one or more tweeters.

The main user-interface 215 is used to control or monitor the main speaker unit 110. For example, the main user-interface 215 is operably coupled to the main controller 405 to control main power, volume, track changes, and connectivity of the main speaker unit 110. The main user-interface 215 includes a combination of digital and analog input or output devices required to achieve a desired level of control and monitoring of the main speaker unit 110. For example, the main user-interface 215 includes display 225 (e.g., a primary display, a secondary display, etc.) and input device 220 such as touch-screen displays, a plurality of knobs, dials, switches, buttons, etc. The display is, for example, a liquid crystal display (LCD), a light-emitting diode (LED) display, an organic LED (OLED) display, an electroluminescent display (ELD), a surface-conduction electron-emitter display (SED), a field emission display (FED), a thin-film transistor (TFT) LCD, etc.

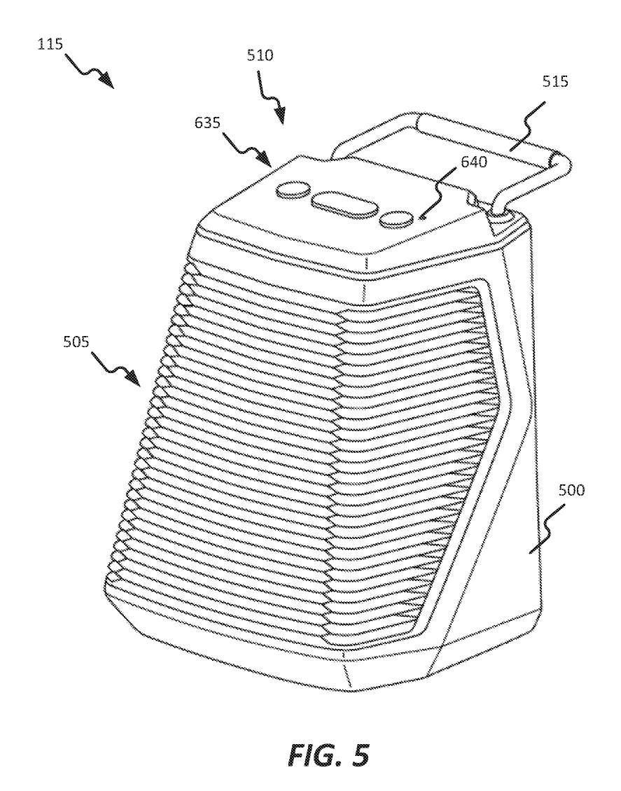

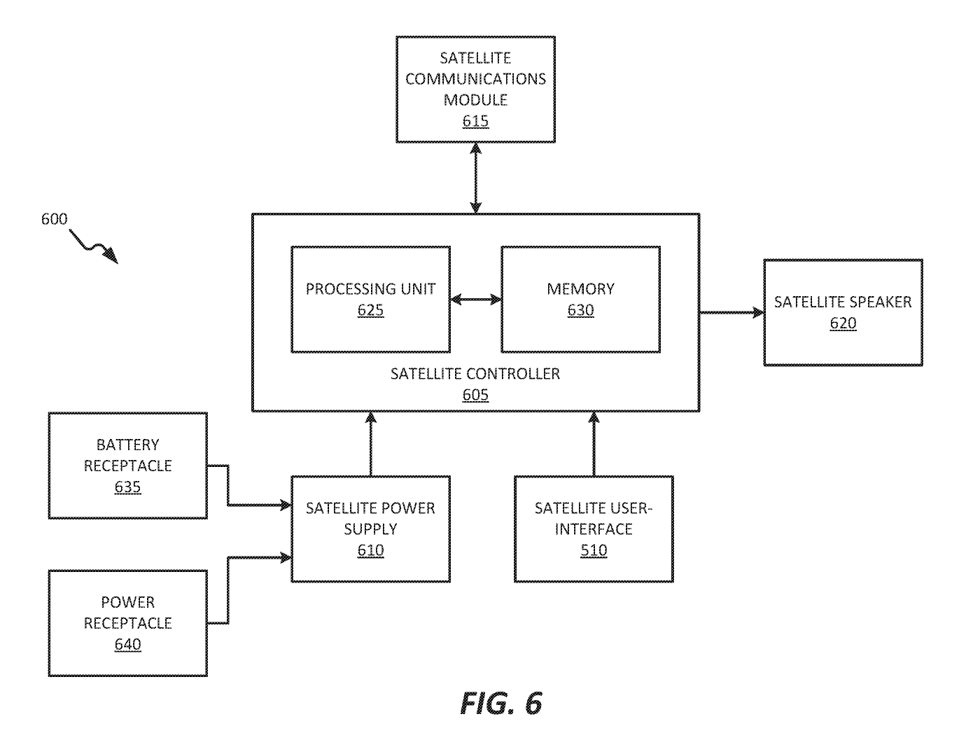

FIG. 5 illustrates a front perspective view of the satellite speaker unit 115. The satellite speaker unit 115 includes a satellite speaker housing 500. Similar to the main speaker housing 205, the satellite speaker housing 500 may be formed of plastic or a similar material. The satellite speaker housing 500 includes a satellite speaker grill 505 covering a satellite speaker 620 (FIG. 6). The satellite speaker unit 115 further includes a satellite user-interface 510 and a handle 515 coupled to the housing 500. In some embodiments, the satellite speaker unit 115 further includes a battery receptacle similar to battery receptacle 300 and/or a power receptacle similar to power receptacle 305, of the main speaker unit 110.

FIG. 6 is a block diagram of a satellite control system 600 of the satellite speaker unit 115. The satellite control system 600 includes a satellite controller 605 electrically and/or communicatively coupled to a satellite power supply 610, a satellite communications module 615, the satellite speaker 620, and the satellite user-interface 510. Similar to the main controller 405, the satellite controller 605 includes a plurality of electrical and electronic components that provide power, operational control, and protection to the components and modules within the satellite controller 605 and/or the satellite speaker unit 115, for example but not limited to, a processing unit 625 and a memory 630. In some embodiments, processing unit 625 and memory 630 are substantially similar to processing unit 425 and memory 430 of the main speaker unit 110.

The satellite power supply 610 supplies a nominal voltage to the satellite controller 605, as well as to other electrical components of the satellite speaker unit 115. The satellite power supply 610 is configured to receive power from a battery pack coupled to a satellite battery receptacle 635 or a satellite power receptacle 640. In some embodiments, the satellite battery receptacle 635 the satellite power receptacle 640 are substantially similar to the battery receptacle 300 and the power receptacle 305 of the main speaker unit 110. The satellite power supply 610 converts power received from the battery pack 635 or power receptacle 640 into the nominal voltage.

The satellite communications module 615 is configured to receive the audio signal from the main communications module 415 via the second communications link 125. The satellite communications module 615 may include a satellite transmitter and a satellite receiver, or a satellite transceiver for providing the second communications link 125. The satellite communications module 615 employs one or more communications protocols, such as but not limited to, a Bluetooth protocol, a SKAA protocol, an Ad Hoc network (for example, ad hoc WiFi), and a WiFi protocol. In some embodiments, the communications links provided by the communications module 415 may use a network, for example, a wide area network (WAN), a local area network (LAN), or a personal area network (PAN).

The satellite speaker 620 is configured to convert the audio signal into a corresponding sound. The satellite speaker 620 may be any electroacoustic transducer or transducers that produces sound in response to the received audio signal. Although illustrated as a single speaker, the satellite speaker 620 may include one or more speaker components, such as but not limited to, one or more drivers, one or more woofers, and one or more tweeters.

The satellite user-interface 510 is used to control or monitor the main speaker unit 110. For example, the satellite user-interface 510 is operably coupled to the main controller 405 to control main power, volume, track changes, and connectivity of the main speaker unit 110. The satellite user-interface 510 includes a combination of digital and analog input or output devices required to achieve a desired level of control and monitoring of the main speaker unit 110. For example, in the illustrated embodiment, the satellite user-interface 510 includes input device 635 (for example, a plurality of knobs, dials, switches, buttons, etc.) and an indicator 640 (for example, a light-emitting diode (LED)). In other embodiments, the satellite user-interface 510 further includes a display (e.g., a liquid crystal display (LCD), a LED display, an organic LED (OLED) display, an electroluminescent display (ELD), a surface-conduction electron-emitter display (SED), a field emission display (FED), a thin-film transistor (TFT) LCD, etc.).

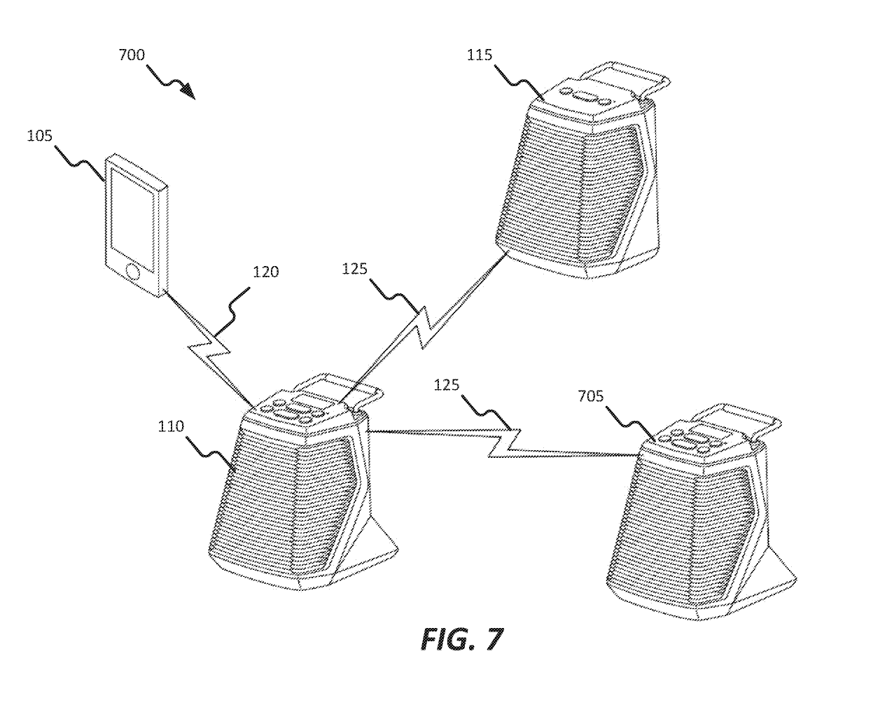

FIG. 7 illustrates a speaker system 700 according to some embodiments of the application. In the illustrated embodiment, speaker system 700 includes the device 105, the main speaker unit 110, the satellite speaker unit 115, and a second main speaker unit 705. In such an embodiment, the device 105 outputs an audio signal to the main speaker unit 110 via a first communications link 120. The main speaker unit 110 may receive the audio signal and convert the audio signal to sound. The main speaker unit 110 may further output the audio signal to the satellite speaker unit 115 via a second communications link 125, as well as to the second main speaker unit 705, via a second communications link 125. The satellite speaker unit 115 and the second main speaker unit 705 may then convert the audio signal to sound. In such an embodiment, the second main speaker unit 705 may be substantially similar to the main speaker unit 110. Although substantially similar to the main speaker unit 110, in such an embodiment, the second main speaker unit 705 may act substantially similar to a satellite speaker unit 115.

The first and second communications links 120, 125 may employ one or more communications protocols. For example, the first and second communications links 120, 125 may employ a Bluetooth protocol, a SKAA protocol, an Ad Hoc network (for example, ad hoc WiFi), a WiFi protocol, etc. In some embodiments, the first communications link 120 and the second communications link 125 are substantially similar. In another embodiments, the first communications link 120 and the second communications link 125 are different.

In some embodiments, the main speaker unit 110 may further include an AM/FM tuner. In such an embodiment, the main speaker unit 110 may receive the AM/FM signal, via the AM/FM tuner, and convert the AM/FM signal to sound. The main speaker unit 110 may further output the AM/FM signal to one or more satellite speaker units 115 via a second communications link 125. The one or more satellite speaker units 115 may then convert the audio signal to sound.

Thus, the application provides, among other things, a speaker system. Various features and advantages of the application are set forth in the following claims.

What is claimed is:

1. A speaker system comprising:
a main speaker unit including a battery receptacle configured to receive a battery pack, the main speaker unit configured to
receive an audio signal from a device using a first communications protocol, and
output the audio signal using a second communications protocol; and
a satellite speaker unit including a satellite battery receptacle configured to receive a second battery pack, the satellite speaker unit configured to receive the audio signal from the main speaker unit using the second communications protocol.

2. The speaker system of claim 1, wherein the first communications protocol is the same as the second communications protocol.

3. The speaker system of claim 1, wherein the first communication protocol is a Bluetooth communications protocol.

4. The speaker system of claim 1, wherein the second communications protocol is a SKAA communications protocol.

5. The speaker system of claim 1, further comprising a second satellite speaker unit configured to receive the audio signal from the main speaker unit using the second communications protocol.

6. The speaker system of claim 1, wherein the main speaker unit further includes a speaker configured to output sound corresponding to the audio signal.

7. The speaker system of claim 1, wherein the satellite speaker unit further includes a satellite speaker configured to output sound corresponding to the audio signal.

8. The speaker system of claim 1, wherein the main speaker unit includes a power receptacle configured to receive AC power.

9. The speaker system of claim 8, wherein the power receptacle is located within the battery receptacle.

10. A speaker unit comprising:
a battery receptacle configured to receive a battery pack;
a communications module configured to receive an audio signal using a first communications protocol and output the audio signal using a second communications protocol; and
a speaker configured to output sound corresponding to the audio signal.

11. The speaker unit of claim 10, wherein the audio signal is received from a device.

12. The speaker unit of claim 10, wherein the audio signal is output to a satellite speaker unit.

13. The speaker unit of claim 12, wherein the satellite speaker unit includes a satellite speaker configured to output sound corresponding to the audio signal.

14. The speaker unit of claim 13, wherein the satellite speaker unit includes a satellite battery receptacle configured to receive a second battery pack.

15. The speaker unit of claim 10, wherein the first communications protocol is the same as the second communications protocol.

16. The speaker unit of claim 10, wherein the first communications protocol is a Bluetooth communications protocol.

17. The speaker unit of claim 10, wherein the second communications protocol is a SKAA communications protocol.

18. The speaker unit of claim 10, further comprising power receptacle configured to receive AC power.

19. The speaker system of claim 18, wherein the power receptacle is located within the battery receptacle.
